(19) United States
(12) Patent Application Publication
(10) Pub. No.: US 2020/0314548 A1
(43) Pub. Date: Oct. 1, 2020

(54) Speaker

(71) Applicant: AAC Technologies Pte. Ltd., Singapore city (SG)

(72) Inventors: Hongjian Hu, Shenzhen (CN); Shuai Li, Shenzhen (CN)

(21) Appl. No.: 16/727,972

(22) Filed: Dec. 27, 2019

(30) Foreign Application Priority Data
Mar. 29, 2019 (CN) 201920416041.7

(51) Int. Cl. H04R 9/02; H04R 9/06; H04R 1/28

(52) U.S. Cl. CPC H04R 9/025; H04R 1/2811; H04R 9/06

(57) ABSTRACT

The present invention discloses a speaker having a frame, a vibrating system and a magnetic circuit system both fixed on the frame. The magnetic circuit system having a yoke fixed on the frame, a main magnet fixed on the yoke, secondary magnets spaced apart from the main magnet and a main pole plate attached to the main magnet. The main pole plate is provided with a through hole. The main magnet includes a main body portion fixed on the yoke and an extending portion protruding and extending from the main body portion toward the vibrating system. The extending portion is located at least partially within the through hole. The speaker of the present invention has better acoustic performance.

### FIELD OF THE PRESENT INVENTION

The present invention relates to the field of electronic equipment technology, and more particularly to a speaker.

### DESCRIPTION OF RELATED ART

With the advent of the mobile Internet era, the number of smart mobile devices is continuously increasing. Among numerous mobile devices, mobile phones are undoubtedly the most common and portable mobile terminal devices. At present, mobile phones have diverse functions, one of which is a high-quality music function, and a speaker in a mobile phone is one of necessary conditions to achieve the high-quality music function.

With the development of miniaturization of a product, the speaker is required to be thinner and thinner. In the related art, the speaker has a frame, a vibrating system and a magnetic circuit system both fixed on the frame. The magnetic circuit system comprises a yoke fixed on the frame, a main magnet fixed on the yoke and a main pole plate attached to the main magnet. The main pole plate is a planar sheet. As the volume of the speaker becomes smaller, the volume of the magnet becomes smaller. As a result, the magnetic field intensity between a magnetic circuit system and a vibrating system will be weakened, and the amplitude of the vibrating system is reduced, which will directly affect the acoustic performance of the speaker.

Therefore, it is desired to provide a new speaker which can overcome the above-mentioned problems.

### SUMMARY OF THE PRESENT INVENTION

The purpose of the present invention is to overcome the above-mentioned problems by providing a speaker with better acoustic performance.

To achieve the above purpose, the present invention disclosures a speaker including a frame, a vibrating system and a magnetic circuit system both fixed on the frame. The magnetic circuit system comprises a yoke fixed on the frame, a main magnet fixed on the yoke, secondary magnets spaced apart from the main magnet and a main pole plate attached to the main magnet. The main pole plate is provided with a through hole. The main magnet includes a main body portion fixed on the yoke and an extending portion extending from the main body portion toward the vibrating system. The extending portion is located at least partially within the through hole.

Preferably, a height of the extending portion along a vibrating direction of the vibrating system is equal to a depth of the through hole along the vibrating direction.

Preferably, a projection of the extending portion along a vibrating direction of the vibrating system is completely overlapped with a projection of the through hole along the vibrating direction.

Preferably, the extending portion protrudes and extends from a middle of the main body portion.

Preferably, the main body portion includes a first surface contacting to the main pole plate. A projection of the main pole plate along a vibrating direction of the vibrating system is completely overlapped with a projection of the first surface.

Preferably, the extending portion includes a top surface arranged away from the main body portion and a sideface connecting the top surface with the first surface. The main pole plate includes an inner wall for surrounding to form the through hole, and the inner wall is fixedly matched with the sideface.

Preferably, the vibrating system further includes a diaphragm fixed on the frame, a voice coil for driving the diaphragm for vibrating and producing sound, and an auxiliary diaphragm. The voice coil is inserted into a gap between the main magnet and the auxiliary magnet. One end of the auxiliary diaphragm is fixed on the frame, and the other end is fixed on the voice coil.

Preferably, the magnetic circuit system includes a secondary pole plate attached to an upper surface of the secondary magnets. The secondary pole plate is an annular configuration which matches with the shape of the frame, and the secondary pole plate is fixedly connected with the frame.

Preferably, the secondary pole plate is provided with locating holes penetrating the secondary pole plate along a vibrating direction of the vibrating system, and locating blocks matching with the shape of the locating holes are provided on the position of the frame corresponding to the locating holes. The locating blocks are fixed on the locating holes respectively.

Preferably, the main body portion is integrally formed with the extending portion, and the extending portion protrudes and extends from a surface of the main body portion close to the vibrating system toward the vibrating system.

Compared with the related art, in the speaker of the present invention, the through hole is provided on the pole core and the corresponding magnet is filled into the through hole. The volume of the magnet is increased with the above structure, thereby the magnetic field intensity between the magnetic circuit system and the vibrating system is increased, and the amplitude of the vibrating system is increased, so that the speaker of the present invention has better the acoustic performance.

### BRIEF DESCRIPTION OF THE DRAWINGS

The embodiment of the present invention will be more clearly understood from the following drawings. It is obvious that the following described drawings are barely some embodiments of the invention. For the person skilled in the art, he can achieve the other drawings from these drawings without any creative work.

FIG. 1 is an illustrative assembled view of a speaker according to the present invention.

FIG. 2 is an illustrative exploded view of the speaker according to the present invention.

FIG. 3 is a cross-sectional view of the speaker taken along a line III-III in FIG. 1.

FIG. 4 is a cross-sectional view of the speaker taken along a line IV-IV in FIG. 1.

FIG. 5 is an illustrative assembled view of a main magnet and a main pole plate according to the present invention.

### DETAILED DESCRIPTION OF THE EXEMPLARY EMBODIMENT

The technical solution in the embodiments of the invention will be clearly and completely described by combining with the drawings in the embodiments of the invention. Apparently, the described embodiments are only parts of the embodiments of the invention, but not all of the embodiments. Based on these embodiments, all the other embodiments that the person skilled in the art can achieve without making creative work, are belong to the scope of protection of the invention.

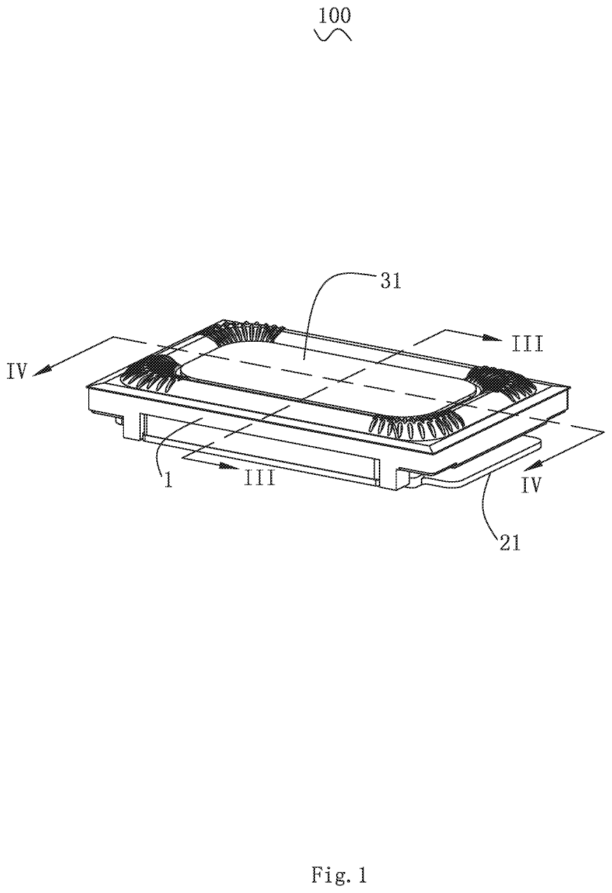

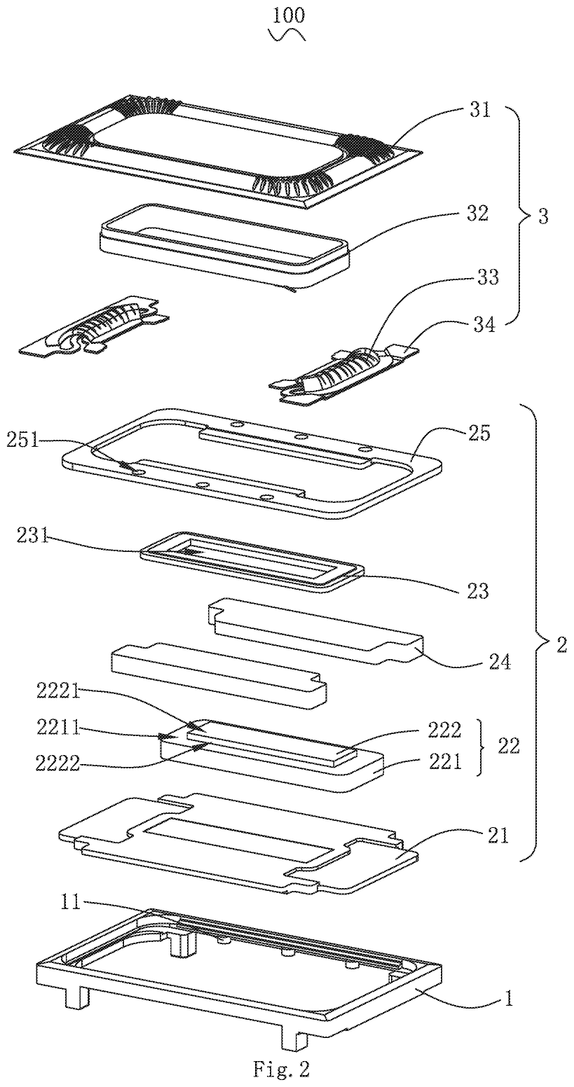

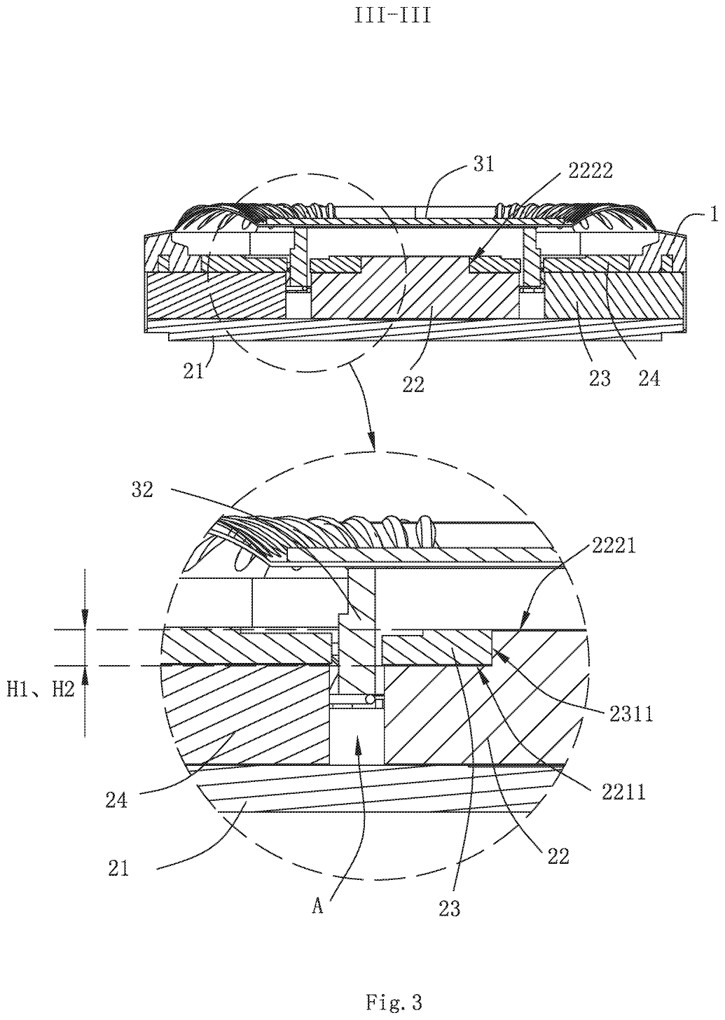

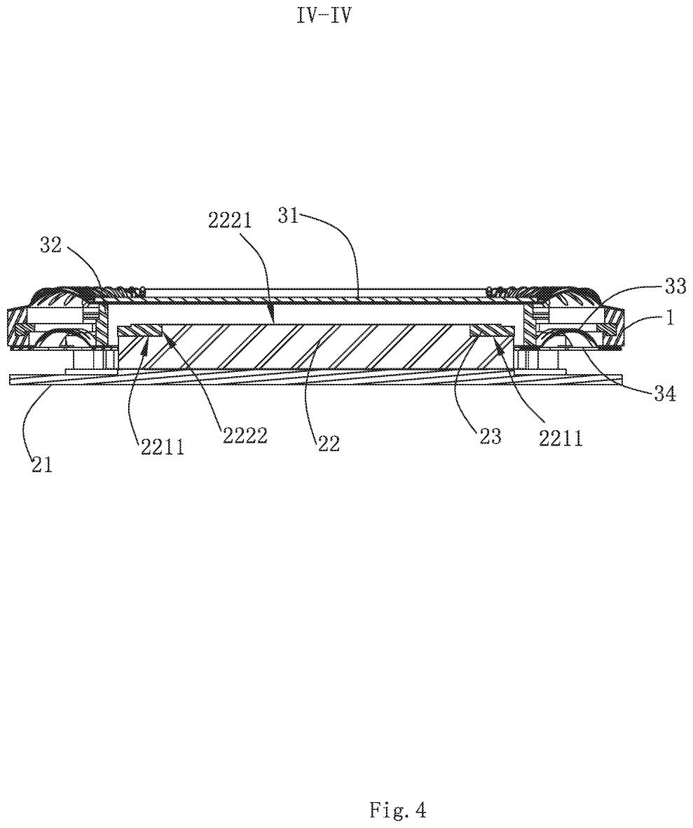

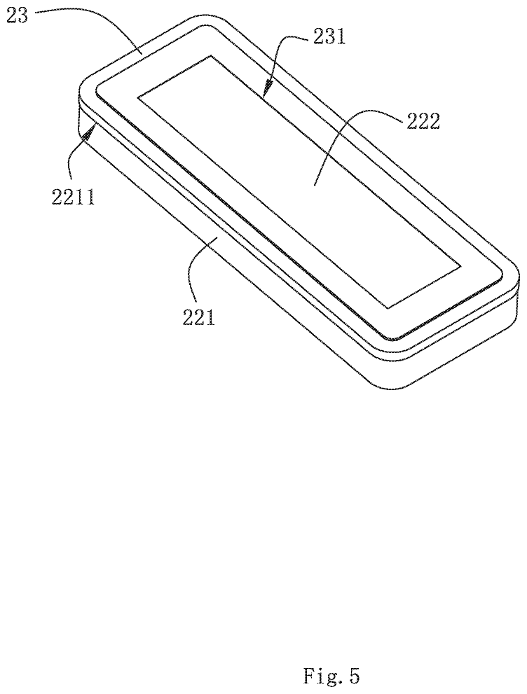

Referring to FIGS. 1-5, FIG. 1 is a illustrative assembled view of a speaker according to the present invention. FIG. 2 is an illustrative exploded view of the speaker according to the present invention. FIG. 3 is a cross-sectional view of the speaker taken along a line III-III in FIG. 1. FIG. 4 is a cross-sectional view of the speaker taken along a line Iv-Iv in FIG. 1. FIG. 5 is an illustrative assembled view of a main magnet and a main pole plate according to the present invention. The present invention disclosures a speaker 100 comprising a frame 1, a magnetic circuit system 2 and a vibrating system 3 both fixed on the frame 1.

The vibrating system 3 includes a diaphragm 31, a voice coil 32, an auxiliary diaphragm 33 and a suspension 34. The diaphragm 31 is fixed above the frame 1. The voice coil 32 is fixed below the diaphragm 31 to generate electromagnetic force with the magnetic circuit system 2 after being provided with electric power, thereby driving the diaphragm 31 to vibrate and produce sound. The auxiliary diaphragm 33 is fixed on the suspension 34. One end of both the auxiliary diaphragm 33 and the suspension 34 is fixed on the voice coil 32, the other end is fixed on the frame 1. The suspension 34 is used for fixing and supporting the voice coil 32 and conducting electricity to the voice coil 32. The auxiliary diaphragm 33 is used for increasing the amplitude of the speaker 100, thereby improving a loudness of the speaker 100.

The magnetic circuit system 2 includes a yoke 21 fixed on the frame 1 and forming a receiving space with the frame 1, a main magnet 22, a main pole plate 23 attached to an upper surface of the main magnet 22, secondary magnets 24 surrounding the main magnet 22 and spaced apart from the main magnet 22, and a secondary pole plate 25 attached to the surface of the secondary magnets 24. Both the main magnet 22 and the secondary magnets 24 are fixed on the yoke 21, wherein the main magnet 22 is located in the intermediate position of the yoke 21, the secondary magnets 24 is located on both sides of the main magnet 22 and spaced apart from the main magnet 22 to form a magnetic gap A. The voice coil 32 is arranged and inserted into the magnetic gap A.

The main pole plate 23 is provided with a through hole 231. The main magnet 22 includes a main body portion 221 fixed on the yoke 21 and an extending portion 222 extending from of the main body portion 221 toward to the vibrating system 3. The extending portion 222 is at least partially located within the through hole 231. The volume of the main magnet 22 is enlarged with the above structure, thereby the magnetic field intensity between the magnetic circuit system 2 and the vibrating system 3 is improved.

Specifically, the extending portion 222 and the main body portion 221 are configured integrally. The extending portion 222 is formed by protruding and extending from an upper surface of the main body portion 221 close to the vibrating system 3 toward the vibrating system 3. A height H1 of the extending portion 222 along a vibrating direction of the vibrating system 3 is equal to a depth H2 of the through hole 231 along a vibrating direction of the vibrating system 3.

Specifically, a projection of the extending portion 222 along the vibrating direction of the vibrating system 3 is completely overlapped with a projection of the through hole 231 along the vibrating direction of the vibrating system 3.

Specifically, the extending portion 222 protrudes and extends from a central position of the surface of the main body portion 221 close to the vibrating system 3 toward the vibrating system 3. The structure can make the magnetic field distribution of the speaker 100 more uniform, thus the vibrating of the diaphragm is stable and balanced.

Specifically, the main body portion 221 includes a first surface 2211 contacting to the main pole plate 25. A projection of the main pole plate 23 along a vibrating direction of the vibrating system 3 is completely overlapped with the first surface 2211.

Specifically, the extending portion 222 includes a top surface 2221 arranged away from the main body portion 221 and a sideface 2222 connecting the top surface 2221 with the first surface 2211. The main pole plate 23 includes an inner wall 2311 for surrounding to form the through hole 231. The inner wall 2311 is fixedly matched with the sideface 2222.

It should be noted that the main pole plate is provided with a through hole, and the way that the main magnet corresponding to the main pole plate is filled into the through hole to enlarge the volume of the main magnet should not be limited to the main magnet 22 and the main pole plate 23. The ways by using any magnets of the speaker 100 and the corresponding pole plate to increase the volume of the magnet, shall all belong to the protection scope of the present invention.

Besides, both the main pole plate 23 and the secondary pole plate 25 are made of magnetically conductive material, which is used for conducting magnet, gathering magnetic field, and improving the magnetic induction performance of a product. In the embodiment, the secondary pole plate 25 is an annular configuration which is matched with the shape of the frame 1. The secondary pole plate 25 is fixedly connected with the frame 1. Specifically, the secondary pole plate 25 is provided with locating holes 251 penetrating the secondary pole plate 25 along the vibrating direction of the vibrating system 3, and locating blocks 11 are provided on the position of the frame 1 corresponding to the locating holes 251. The locating blocks 11 are fixed into the locating holes 251 respectively. The secondary pole plate 25 is fixed on the frame 1 through the above structure.

In the speaker of the present invention, the main pole plate is provided with a through hole and the main magnet corresponding to the through hole is filled into the through hole. The volume of the magnet is enlarged with the above structure, thereby the magnetic field intensity between the magnetic circuit system and the vibrating system is improved, and the amplitude of the vibrating system is increased, so that the speaker of the present invention has better acoustic performance.

The above is only preferred embodiment of the present invention, it should be noted that those skilled in the art can still make improvements without departing from the inventive concept, but these are all belong to the protection scope of the present invention.

What is claimed is:

1. A speaker, comprising a frame, a vibrating system and a magnetic circuit system both fixed on the frame, the magnetic circuit system comprising a yoke fixed on the frame, a main magnet fixed on the yoke, secondary magnets spaced apart from the main magnet and a main pole plate attached to the main magnet;
wherein, the main pole plate is provided with a through hole, the main magnet includes a main body portion fixed on the yoke and an extending portion extending from the main body portion toward the vibrating system, the extending portion is located at least partially within the through hole.

2. The speaker according to claim 1, wherein a height of the extending portion along a vibrating direction of the vibrating system is equal to a depth of the through hole along the vibrating direction.

3. The speaker according to claim 1, wherein a projection of the extending portion along a vibrating direction of the vibrating system is completely overlapped with a projection of the through hole along the vibrating direction.

4. The speaker according to claim 1, wherein the extending portion protrudes and extends from a middle of the main body portion.

5. The speaker according to claim 1, wherein the main body portion includes a first surface contacting to the main pole plate; a projection of the main pole plate along a vibrating direction of the vibrating system is completely overlapped with a projection of the first surface.

6. The speaker according to claim 5, wherein the extending portion includes a top surface arranged away from the main body portion and a sideface connecting the top surface with the first surface; the main pole plate includes an inner wall for surrounding to form the through hole, and the inner wall is fixedly matched with the sideface.

7. The speaker according to claim 1, wherein the vibrating system further includes a diaphragm fixed on the frame, a voice coil for driving the diaphragm for vibrating and producing sound, and an auxiliary diaphragm; the voice coil is inserted into a gap between the main magnet and the auxiliary magnet; one end of the auxiliary diaphragm is fixed on the frame, the other end is fixed on the voice coil.

8. The speaker according to claim 1, wherein the magnetic circuit system includes a secondary pole plate attached to an upper surface of the secondary magnets, the secondary pole plate is an annular configuration which matches with the shape of the frame, and the secondary pole plate is fixedly connected with the frame.

9. The speaker according to claim 8, wherein the secondary pole plate is provided with locating holes penetrating the secondary pole plate along a vibrating direction of the vibrating system, and locating blocks matching with the shape of the locating holes are provided on the position of the frame corresponding to the locating holes, the locating blocks are fixed on the locating holes respectively.

10. The speaker according to claim 1, wherein the main body portion is integrally formed with the extending portion, and the extending portion protrudes and extends from a surface of the main body portion close to the vibrating system toward the vibrating system.
